(19) United States
(12) Patent Application Publication
(10) Pub. No.: US 2016/0162861 A1
(43) Pub. Date: Jun. 9, 2016

(54) MANAGING ELECTRONIC TRANSACTIONS

(71) Applicant: VERIZON PATENT AND LICENSING, INC., Arlington, VA (US)

(72) Inventors: Paul Sharad TUSCANO, Columbia, MD (US); Saloni POKHARNA, Atlanta, GA (US)

(21) Appl. No.: 14/559,788

(22) Filed: Dec. 3, 2014

(51) Int. Cl. G06Q 20/20; G06Q 20/32

(52) U.S. Cl. CPC G06Q 20/202; G06Q 20/32

(57) ABSTRACT

A system and method are provided for electronic transaction management. An input is received from a mobile device over a wireless communication network. The input includes an e-mail address associated with a user of the mobile device and payment data associated with a sale transaction of the user. The e-mail address associated with the user is extracted from the input. A request is sent to a server for sending information associated with the sale transaction to the e-mail address. The payment data associated with the user is extracted from the input. The payment data is sent to the server, wherein the server determines information associated with the sale transaction based on the payment data. The information associated with the sale transaction is stored in a memory location associated with the server.

### BACKGROUND

Mobile devices have the capability of being used at various Point of Sale (POS) locations where retail transactions are performed. A user (e.g., a customer) can make payments via a mobile device for goods or services provided by a merchant. The merchant will normally issue a receipt for the transaction. The receipt can be either printed at the POS location or sent to an e-mail address provided by the customer. Known procedures currently used for transaction management include consumer being asked by the merchant at the POS location to enter their e-mail address in a terminal or a cashier enters the consumer's e-mail address into the terminal for marketing purpose or for sending an electronic receipt to the e-mail address. As part of the payment process, the e-mail can act as a fraud early warning, for example, by informing an owner of a credit card of a transaction on their card.

However, entering an e-mail address into the terminal causes extra time added to the payment process. In addition, there is a possibility of misspelling or mistyping the address resulting in the consumer never receiving their electronic receipt and the merchant missing the opportunity to market to active customers.

Therefore, a need exists for storing a user's e-mail address on a mobile device of the user or in a secure element of the mobile device and transmitting the e-mail address as part of the user profile for payment or loyalty transaction at a point of sale.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a high-level functional block diagram of an exemplary network that provides various communications for mobile devices and supports an example of the electronic transaction management, according to one implementation.

FIG. 2 is a schematic illustration of a transaction management platform, according to an implementation.

FIG. 3 is an exemplary process for providing electronic transaction management service.

FIGS. 4A-4B are exemplary flow diagrams for providing electronic transaction management service.

FIG. 5 is a high-level functional block diagram of an exemplary non-touch type mobile device that may utilize the electronic transaction management service through a network/system like that shown in FIG. 1.

FIG. 6 is a high-level functional block diagram of an exemplary touch screen type mobile device that may utilize the electronic transaction management service through a network/system like that shown in FIG. 1.

FIG. 7 is a diagram of an exemplary process for providing electronic transaction management service.

FIG. 8 is a simplified functional block diagram of an exemplary computer that may be configured as a host or server.

FIG. 9 is a simplified functional block diagram of an exemplary personal computer or terminal device.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

Electronic payment systems using computer networks are becoming one of the most common methods of transaction when selling and buying products or services. An electronic transaction may include various activities such as buyer and/or seller authentication, fund transfer, and providing electronic receipts to the buyer. Electronic payment systems typically use the World Wide Web or mobile networks for at least part of a transaction. They may also use other technologies such as e-mail. With the recent widespread use of mobile devices, various electronic payment systems provide payment options via mobile devices. For example, a customer can make a payment for a product or service at a Point of Sale (POS) location (e.g., a store) using a mobile device. A POS server can communicate payment data to a merchant server to process the payment and provide a receipt to the customer. Some payment systems include an optional electronic receipt being sent to an e-mail address provided by the customer. Such systems require from the customer or a cashier to enter an e-mail address into a terminal at the POS location where retail transactions are initiated. However, entering an e-mail address into the terminal may cause delays in check out process and the possibility of misspelling or mistyping the address results in the consumer not receiving their electronic receipt and the merchant missing the opportunity to market to active customers.

In one implementation, a transaction management platform is provided that enables a POS device to obtain a contact information (e.g., and email address) of a user (e.g., a customer at a store) from a mobile device of the user (e.g., from a user profile on the mobile device) via a wireless network (e.g., a mobile network or a short range network) and send electronic receipts for the user's payments to various merchants via e-mail or other messaging services such as, for example, text messages to the user via the obtained contact information. The transaction management platform may also store electronic receipts in a repository such that the customer can have access to his/her payment electronic receipts for various merchants in one place and a merchant can have access to the electronic receipts it provided to all customers. The transaction management platform can provide various functions to customers and merchants for sorting, selecting and categorizing the electronic receipts in the repository.

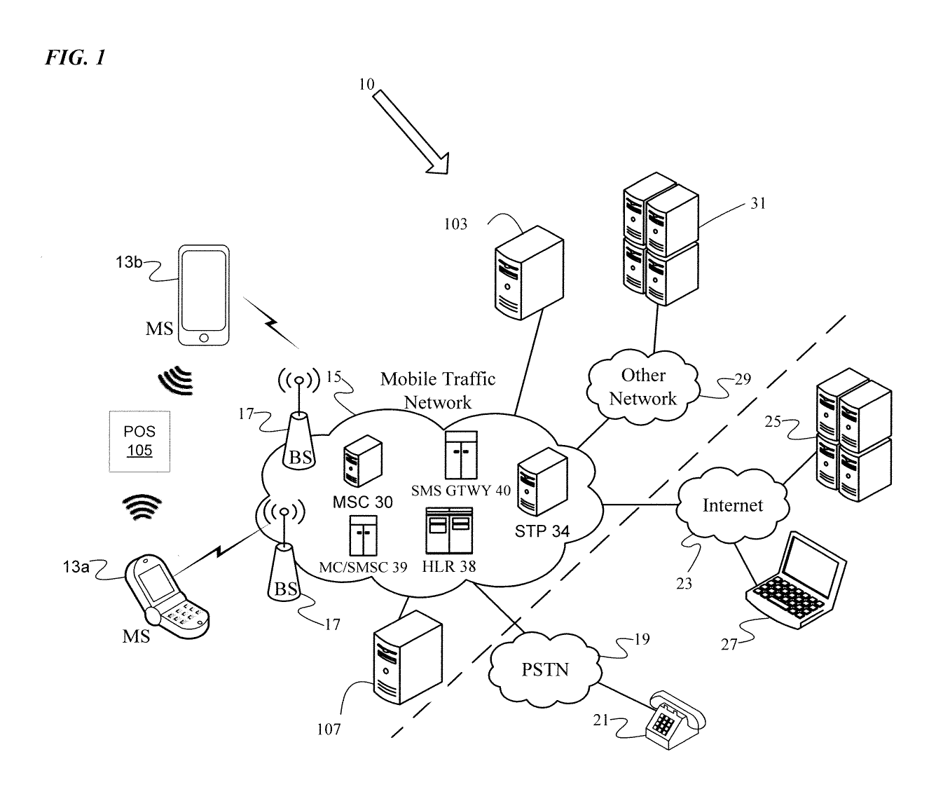

Reference now is made in detail to the examples illustrated in the accompanying drawings and discussed below. FIG. 1 is a high-level functional block diagram of an exemplary network 10 that provides various communications for mobile devices and supports an example of the transaction management service by a transaction management platform 103, according to one implementation. The transaction management platform 103 can provide transaction management services for application servers 31 and 25. The application servers 31 and 25 may be associated with merchants and may provide payment services to the mobile devices 13a and 13b and the user terminal 27. The example shows simply two mobile devices 13a and 13b as well as a mobile communication network 15. The stations 13a and 13b are examples of mobile devices that may be used for accessing the payment services provided by the application servers 25 or 31 and the transaction management services provided by the transaction management platform 103, for example, via a POS device 105 or directly via the communication network 15 without a POS device. The application servers 25, 31 may communicate with a mobile device 13a or 13b via the transaction management platform 103, via a POS device 105, directly via the communication network 15, or a combination thereof. Similarly, the transaction management platform 103 may communicate with a mobile device 13a or 13b via a POS device 105, via an application server 25 or 31, directly via the communication network 15, or a combination thereof. The transaction management platform 103 can be located anywhere throughout the mobile communication network 10.

The user may purchase an item in a variety of manners. In one example, the user may use the user's mobile device 13a or 13b to pay for an item at a POS location (e.g., inside a store). In another example, the user may use a non-mobile device implement, such as a separate credit card or bank card, to pay for an item at the POS location. In yet another example, the user may use his/her credit card or bank card to purchase an item online by accessing a website associated with a merchant.

In the first scenario, in which the user uses his/her mobile device 13a or 13b to purchase an item from a merchant at a POS location (e.g., a store), the user may tap or bring the user's mobile device 13a or 13b close to a POS device 105. In various implementations, close to is a distance that is sufficiently close to enable the mobile device 13a or 13b to interact with the POS device 105 using the desired communication, for example, Near Field Communication (NFC). As a result, transaction data may be communicated from the mobile device 13a or 13b to the POS device 105. The transaction data may be previously stored in the mobile device 13a or 13b manually by the user, or automatically at the time of a previous transaction. The transaction data may also be retrieved by the mobile device from a transaction account of the user (e.g., an account at a server 107). The transaction data may include payment information and contact information of the user. The mobile device 13a or 13b may be previously programmed to include the user's credit card information and/or bank information. Similarly, the mobile device 13a or 13b may be previously programmed to include the user's contact information such as, for example, e-mail address.

The transaction data may be communicated to the POS device 105 via a wireless network. The wireless network may include a mobile communication network or a short range wireless network. In keeping with the previous example, where the user is in proximity of the POS device 105, the wireless network may include a Bluetooth® or via an NFC network. To this end, the mobile device 13a or 13b may include an NFC chip for transmitting transaction data and the POS device 105 may have an NFC chip for receiving the transmitted transaction data. As noted above, the transaction data may include payment information and contact information. The payment information may include one or more credit card or bank card information. The user may use the user interface of the mobile device 13a or 13b to select a specific card to use from among a plurality of cards stored at the mobile device to pay for the item. Alternatively or additionally, the user may use the user interface at the POS device 105 to select a specific card to use from among a plurality of cards stored at the mobile device to pay for the item.

The contact information may be communicated to the POS device 105 along with the payment information and without the user having to type in the email address at the POS device 105. In another example, the contact information may be communicated to the POS device 105 before or after sending the payment information to the POS device 105. In either case, the contact information may be communicated from the mobile device 13a or 13b via the wireless communication network to the POS device 105.

Upon receiving the transaction data, the POS device 105 may forward the transaction data to an application server 25 or 31, which in turn may forward the transaction data to the transaction management platform 103. The transaction management platform 103 receives the transaction data including a user profile (e.g., including contact information of the user) and payment data associated with the transaction (e.g., a payment for the purchase). The transaction management platform 103 may then extract the contact information such as an e-mail address or a phone number of the user from the user profile. The transaction management platform 103 may also extract the payment data from the transaction data. The transaction management platform 103 may send the payment data to the server of the company issuing the payment card (e.g., a server 107 of credit card company or a bank) to seek authorization for the payment. The transaction management platform 103 may also send a request to the mobile device 13a or 13b asking for user approval of receiving information associated with the transaction such as, for example, an electronic receipt, by e-mail or via a messaging system to the mobile device 13a or 13b. The transaction management platform 103 may also send other requests to the mobile device 13a or 13b asking for user approval of saving the message (e.g., e-mail) containing the information associated with the transaction in a repository, saving the electronic receipt in a repository, saving the merchant's information in the repository, etc. To this end, the transaction management platform 103 may directly communicate with the mobile device 13a or 13b over a mobile communication network or may indirectly communicated with the mobile device 13a or 13b via the POS device 105, or via the application server 25 or 31 through the mobile communication network.

In the above scenario, the transaction management platform 103 and the servers 25 and 31 are shown to be separate entities from the POS device 105. In a slightly different implementation, however, the transaction management platform 103 and the servers 25 or 31 may be part of the POS device 105 and there may be no need for the POS device 105 to transmit the transaction data over the network. In yet another alternative, the POS device 105 may forward the transaction data to the server 25 or 31 and the server 25 or 31 may segregate the payment data and the contact information. The server 25 or 31 may forward the payment data to the payment server 107 for authorization and may forward the contact information to the transaction management platform 103. In yet another alternative, the server 25 or 31 may forward the transaction data to the payment server 107 and the payment server 107 may segregate the payment information and the contact information and may forward the contact information to the transaction management platform 103.

In the above scenario, if the user approves receiving an electronic receipt via e-mail or via the mobile device 13a or 13b, the transaction management platform 103 communicates the user approval to the application server 25 or 31 and the application server 25 or 31 sends the electronic receipt to the user's contact information. In addition, if the user approves saving the message (e.g., e-mail) containing the information associated with the transaction in a repository, saving the electronic receipt in a repository, saving the merchant's information in the repository, etc. the transaction management platform 103 stores the information approved by the user in one or more repositories controlled by the transaction management platform 103 or by the application server 25 or 31. Furthermore, if the payment server 107 disapproves user's payment data, the payment server 107 may send a warning to the application server 25 or 31 and prevent the transaction from going through. In such instances, the transaction management platform 103 may send a warning to the user's contact information (e.g., e-mail) and informing the user that the transaction has been interrupted.

In another scenario, in which the user uses his credit card or bank card to pay for an item at the POS location (e.g., a store), the user may swipe his/her credit card or bank card to a POS device 105. As a result, transaction data may be communicated from the card to the POS device 105. The transaction data may be also retrieved by the mobile device from a transaction account of the user (e.g., an account at a server 107). The transaction data may include payment information. The transaction management platform 103 may communicate to the user via the POS 105 asking whether the user is willing to receive transaction information, for example, via e-mail. The transaction management platform 103 may also ask the user to tap or bring the user's mobile device 13a or 13b close to the POS device 105. As a result, contact information may be communicated from the mobile device 13a or 13b to the POS device 105. The mobile device 13a or 13b may be previously programmed to include the user's contact information such as, for example, e-mail address.

In yet another scenario, the user uses his/her credit card or bank card to purchase an item online by accessing a website associated with a merchant. The user may use his/her mobile device 13a or 13b or a user terminal 27 to purchase an item from a merchant at a website (e.g., merchant's online store). At the time of payment, the transaction management platform 103 may ask the user whether the user is willing to enter the payment data and user's contact information from a user profile on the mobile device 13a or 13b or user terminal 27. If the user approves entering data from the mobile device, the transaction management platform 103 may obtain user's payment data and contact information directly from the mobile device 13a or 13b or user terminal 27 via the communication network 15 and send the obtained information to application server 25 or 31.

Alternatively, the application server 25 or 31 may obtain the transaction information from the mobile device 13a or 13b or user terminal 27. In such instances, as discussed above, the application server 25 or 31 may extract the payment data from the transaction information and send the payment data to a bank or credit card server 107. The application server 25 or 31 may also extract the user contact information from the transaction data and send the contact information to the transaction management platform 103. Similarly, the transaction data may be previously stored in the mobile device 13a or 13b or user terminal 27 by the user. The transaction data may be also retrieved by the mobile device from a transaction account of the user (e.g., an account at a server 107). The transaction data may include payment information and contact information of the user. The mobile device 13a or 13b may be previously programmed to include the user's credit card information and/or bank information. Similarly, the mobile device 13a or 13b may be previously programmed to include the user's contact information such as, for example, e-mail address. The transaction data may be communicated to the transaction management platform 103 via a wireless network. The wireless network may include a mobile communication network.

Upon extracting the contact information and/or the payment data from the input, as previously discussed, the transaction management platform 103 may send the extracted contact information (e.g., the e-mail address, phone number, etc.) and the extracted payment data to an application server 25 or 31 associated with the merchant, such that the application server 25 or 31 can process the payment. An application server 25 or 31 can include an enterprise application that manages payment transactions. As an example, application server 25 or 31 may initiate payment transactions to various merchants from mobile devices 13a or 13b of customers by communicating with one or more other servers 107 of financial institutions such as, for example, credit companies, banks, etc. Alternatively, the one or more servers associated with the financial companies may be collocated with or incorporated within the application server 25 or 31.

Upon completion of the transaction, the application server 25 or 31 or the transaction management platform 103 can send information related to the transaction such as the electronic receipt to the user's e-mail address or to the mobile device 13a or 13b. In addition, the transaction management platform 103 may also manage a repository of the electronic receipts, a repository of contact information, a repository of merchant information, etc., and provide access to the repository to the application servers 25 and 31 and to the user via mobile devices 13a and 13b or via a user terminal 27.

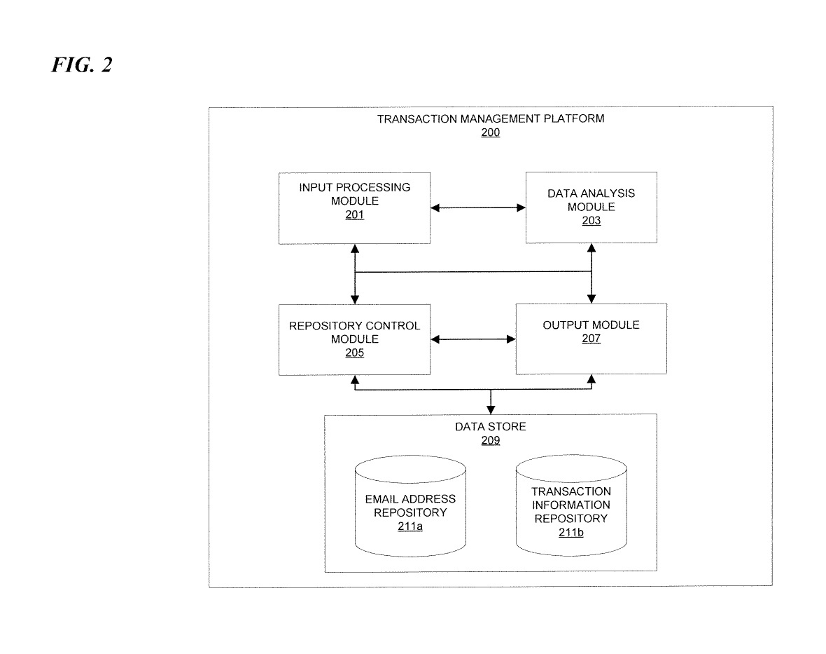

It is noted that the transaction management platform 103 may have one or more frontend components such as an input module associated with the POS device 105 and one or more backend components such as a repository of electronic receipts that can be located anywhere within the network system 10. The transaction management platform 103 as shown in FIG. 1, and later in FIG. 2, represent the backend and frontend components in one location even though the components can be physically distributed within the network system 10.

Although two mobile devices are shown, the network will provide similar communications for many other similar users as well as for mobile devices/users that may not participate in the services. The network 15 provides mobile wireless communications services to those stations as well as to other mobile devices (not shown), for example, via a number of base stations (BSs) 17. The present techniques may be implemented in any of a variety of available mobile networks 15 and/or on any type of mobile device compatible with such a network 15, and the drawing shows only a very simplified example of a few relevant elements of the network 15 for purposes of discussion here.

The wireless mobile communication network 15 might be implemented as a network conforming to the code division multiple access (CDMA) IS-95 standard, the 3rd Generation Partnership Project 2 (3GPP2) wireless Internet Protocol (IP) network standard or the Evolution Data Optimized (EVDO) standard, the Global System for Mobile (GSM) communication standard, a time division multiple access (TDMA) standard or other standards used for public mobile wireless communications. The mobile devices 13a and 13b may be capable of voice telephone communications through the network 15, and for accessing applications and services provided by application servers 31 and 25 and the transaction management platform 103. The exemplary devices 13a and 13b are capable of data communications through the particular type of network 15 (and the users thereof typically will have subscribed to data service through the network). The mobile devices 13a and 13b are also capable of establishing radio communications such as Near Field Communication (NFC) with each other and with other devices such as the transaction management platform 103.

The network 15 allows users of the mobile devices such as 13a and 13b (and other mobile devices not shown) to initiate and receive telephone calls and messages to each other as well as through the public switched telephone network or “PSTN” 19 and telephone stations 21 connected to the PSTN. The network 15 typically offers a variety of data services via the Internet 23, such as downloads, web browsing, e-mail, etc. By way of example, the drawing shows a laptop PC type user terminal 27 as well as an application server 25 connected to the Internet 23; and the data services for the mobile devices 13a and 13b via the Internet 23 may be with devices like those shown at 25 and 27 as well as with a variety of other types of devices or systems capable of data communications through various interconnected networks. The mobile devices 13a and 13b of users also can receive and execute applications written in various programming languages, as discussed in more detail below.

Mobile devices 13a and 13b can take the form of portable handsets, smartphones or personal digital assistants, although they may be implemented in other form factors. Program applications, provided by the internet server 25 or the application server 31 to the mobile devices 13a, 13b and computing devices 27 can be configured to execute on many different types of mobile devices 13a and 13b. For example, a mobile device application can be written to execute on a binary runtime environment for mobile (BREW-based) mobile device, a Windows Mobile based mobile device, Android, I-Phone, Java Mobile, or RIM based mobile device such as a BlackBerry or the like. Some of these types of devices can employ a multi-tasking operating system.

The mobile communication network 10 can be implemented by a number of interconnected networks. Hence, the overall network 10 may include a number of radio access networks (RANs), as well as regional ground networks interconnecting a number of RANs and a wide area network (WAN) interconnecting the regional ground networks to core network elements. A regional portion of the network 10, such as that serving mobile devices 13a and 13b, can include one or more RANs and a regional circuit and/or packet switched network and associated signaling network facilities.

Physical elements of a RAN operated by one of the mobile service providers or carriers include a number of base stations represented in the example by the base stations (BSs) 17. Although not separately shown, such a base station 17 can include a base transceiver system (BTS), which can communicate via an antennae system at the site of base station and over the airlink with one or more of the mobile devices 13a and 13b, when the mobile devices are within range. Each base station can include a BTS coupled to several antennae mounted on a radio tower within a coverage area often referred to as a “cell.” The BTS is the part of the radio network that sends and receives Radio Frequency (RF) signals to/from the mobile devices 13a and 13b that are served by the base station 17.

The radio access networks can also include a traffic network represented generally by the cloud at 15, which carries the user communications and data for the mobile devices 13a and 13b between the base stations 17 and other elements with or through which the mobile devices communicate. In some examples, the mobile traffic network 15 includes network elements that support mobile station media content transfer services such as mobile switching centers (MSCs) 30 and signal transfer points (STP) 34. The network can also include other elements that support functionality other than device-to-device media transfer services such as messaging service messages and voice communications. Examples of other network elements that may be used in support of messaging service message communications include, but are not limited to, message centers (MCs) 39, home location registries (HLRs) 38, simple messaging service (SMS) gateways 40, and other network elements such as wireless internet gateways (WIGs), and visitor location registers (VLRs) (not shown). Other individual elements such as switches and/or routers forming the traffic network 15 are omitted here for simplicity. It will be understood that the various network elements can communicate with each other and other aspects of the mobile communications network 10 and other networks (e.g., the public switched telephone network (PSTN) and the Internet) either directly or indirectly.

The mobile switching center (MSC) 30 is responsible for managing communications between the mobile device and the other elements of the network 10. In addition, the MSC 30 is responsible for handling voice calls and messaging service message requests as well as other services (such as conference calls, FAX and circuit switched data, messaging service communications, Internet access, etc.). The MSC 30 sets up and releases the end-to-end connection or session, and handles mobility and hand-over requirements during the call. The MSC 30 also routes messaging service messages to/from the mobile devices 13a or 13b, typically from/to an appropriate MC 39. The MSC 30 is sometimes referred to as a “switch.” The MSC 30 manages the cell sites, the voice trunks, voice-mail, and SS7 links.

The message center (MC) 39, in some examples, allows messaging service messages to be exchanged between mobile telephones and other networks. For SMS messaging, for example, the MC 39 receives packet communications containing text messages from originating mobile devices and forwards the messages via the signaling resources and the signaling channels to the appropriate destination mobile devices. The MC 39 may receive messages from external devices for similar delivery to mobile devices, and the MC 39 may receive similar messages from mobile device 13a or 13b and forward them to servers or terminal devices, in either case, via an Internet Protocol (IP) packet data network.

In some examples, the MC 39 can also be considered or include functionality that may be considered that of a Short Messaging Service Message Center (SMSC) or a Message Register (MR). Wireless carriers developed the short message service (SMS) to transmit text messages for display on the mobile devices. In many existing network architectures, the SMS traffic uses the signaling portion of the network 15 to carry message traffic between a Short Message Service Center (SMSC) 39 and the mobile devices. The SMSC 39 supports mobile device to mobile device delivery of text messages. However, the SMSC 39 also supports communication of messages between the mobile devices and devices coupled to other networks. For example, the SMSC 39 may receive incoming IP message packets from the Internet 23 for delivery via the network 15, one of the base stations 17 and a signaling channel over the air link to a destination mobile device. For this later type of SMS related communications, the network 10 also includes one or more SMS gateways 40.

In other examples, the MC 39 includes functionality related to the Enhanced Messaging Service (EMS) or Multimedia Messaging service (MMS). An EMS message has special text formatting (e.g., such as bold or italic), animations, pictures, icons, sound effects and special ring tones. MMS messages support the sending and receiving of multimedia messages (e.g., images, audio, video and their combinations) to (or from) MMS-enabled mobile devices. In some examples, the MC 39 is considered in whole or in part a multimedia messaging service center (MMSC).

Although a single MC 39 is shown, a network 10 has many geographically dispersed MCs 39. The MCs 39 includes destination routing tables (DRTs). In essence the DRTs are databases within the MCs 39. A DRT contains a list of the MDNs which are associated with the various MCs 39. For example, a first MDN is associated with a MC 39 in Minnesota while a second MDN is associated with a MC 39 in Virginia. The DRTs are used to determine which MC 39 should attempt to deliver an incoming messaging service message to the destination MDN. For example, if a user associated with the MC in Minnesota sends an SMS to a user associated with the MC 39 in Virginia, the Minnesota MC 39 sends the SMS to the Virginia MC 39 for delivery to the destination MDN. The communication among the MCs 39 occurs using known protocols such SMPP and the like.

The HLR 38, in some examples, stores a subscriber profile for each of the wireless subscribers and their associated mobile devices 13. The HLR 38 may reside in an MSC 30 or in a centralized service control point that communicates with the MSC(s) 30 via an out-of-band signaling system such as an SS7 network. The HLR 38 stores for each mobile subscriber the subscriber's mobile directory number (MDN), the mobile identification number (MIN), and information specifying the wireless services subscribed to by the mobile subscriber, such as numeric paging or text-based paging, data communication services, etc. Of course, the HLR 38 can also be a stand-alone device. The HLR 38 also tracks the current point of attachment of the mobile device to the network, e.g., the identification of the MSC 30 with which the mobile device is currently registered to receive service.

The visitor location register (VLR) (not shown) is, in some examples, a temporary database of the mobile devices that have roamed into the particular area which the VLR serves. The VLRs for a region often are implemented in or in association with a MSC 30. Each base station 17 in the network is served by a single VLR; hence a subscriber cannot be present in more than one VLR at a time. The data stored in the VLR has either been received from the HLR 38, or collected from the mobile device.

The SMS gateway 40 provides functionality to transport messaging service messages to other mobile communication networks and also receive messaging service messages from other networks. The SMS gateway 40 may support communications using the SMPP protocol. SMS gateways 40 can be Short Message Peer-to-Peer gateways used to connect the wireless communication network (such as an Internal Protocol IP network on the left of the SMS Gateway 40 in FIG. 1) to another network (such as a public Internet network on the right of the SMS Gateway 40 in FIG. 1). The SMS Gateway 40 allows the MC 39 to receive and send messages in IP packet format. The SMS Gateway 40 is an entity within the wireless network 10 that acts as an intermediary between the wireless service provider network and other networks. For example, the SMS Gateway 40 converts messages in protocol(s) used by other applications and devices, e.g. Extensible Markup Language (XML), Hypertext Mail Protocol (HTMP), etc., to and from the short SMPP protocol. The SMPP messages may ride on IP transport, e.g., between the SMS Gateway 40 and the MC 39.

In addition, the traffic network portion 15 of the mobile communications network 10 connects to a private data network 29. The private data network 29 connects to the traffic network portion 15 via a gateway (not shown). The gateway provides protocol conversions between the protocols used by the traffic network 15 and the protocols used by the private data network 29. The private data network 29 is in communication with various auxiliary services servers, e.g., such as those providing additional services to the users of the network 10, and/or to operations support personnel of the service provider or carrier that operates the network 10. The private data network 29 is also in communication with the transaction management platform 103 and application servers 25 and 31.

In one aspect, the transaction management platform 103 allows application servers 25 or 31 and mobile devices 13a or 13b to uniquely communicate transaction data for purposes that include, but are not limited to, payment for services and products purchased by a user of mobile device 13a or 13b from a merchant associated with the application server 25 or 31.

While the present disclosure is discussed generally with reference to e-mails it is to be appreciated that the disclosed implementations are not limited to e-mails and can be applied to any form of messaging and communication, including, but not limited to, text, video, audio, multimedia or any combination thereof.

The carrier will also operate a number of systems that provide ancillary functions in support of the communications services and/or application services provided through the network 10, and those elements communicate with other nodes or elements of the network 10 via one or more private IP type packet data networks 29 (sometimes referred to as an Intranet), i.e., a private networks. Generally, such systems are part of or connected for communication via the private network 29. A person skilled in the art, however, would recognize that systems outside of the private network could serve the same functions as well. Examples of such systems, in this case operated by the network service provider as part of the overall network 10, which communicate through the intranet type network 29, include one or more application servers 31.

A mobile device 13a or 13b communicates over the air with a base station 17 and through the traffic network 15 for various voice and data communications, e.g. through the Internet 23 with an application server 25 and/or with application servers 31. To insure that the previously discussed transaction services offered by the application servers 25 or 31 and by the transaction management platform 103, are available to only authorized devices/users, the providers of the services may also deploy an authentication service. For example, the transaction management platform 103 or the application server 25 or 31 may request from the user to enter a password, a biometric input such as a fingerprint, etc. and compare the entry with a password or biometric input on file in a memory location of the transaction management platform 103 or the application server 25 or 31, prior to allowing the user of the mobile device 13a or 13b to proceed with a transaction.

Servers such as application servers 25 and 31 may provide any of a variety of common application or service functions in support of or in addition to an application program running on the mobile device 13a, 13b, or a user terminal 27. However, for purposes of further discussion, we will focus on functions thereof in support of the transaction management service. For a given service, including the transaction management service, an application program within the mobile device may be considered as a ‘client application’ and the programming at 103, 25 or 31 may be considered as the ‘server’ application for the particular service.

FIG. 2 is a schematic illustration of a transaction management platform, according to an implementation. The transaction management platform 200 can be similar to the transaction management platform 103 of FIG. 1. As previously discussed, the transaction management platform 103 can be located anywhere throughout the mobile communication network 10. For example, the transaction management platform 103 or one or more modules of the transaction management platform 103 can be located within a POS device 105, within an application server 25 or 31, or in separate locations within the network 10. In other words, the platform 103 in FIG. 1 can be a POS device 105 containing one or more components of a transaction management platform. As shown in FIG. 2, the transaction management platform 200 may include an input processing module 201, a data analysis module 203, a repository control module 205, an output module 207, and a data store 209. Moreover, the data store 209 may include an e-mail address repository 211a and a transaction information repository 211b. As used herein, a module can be, for example, any assembly and/or set of operatively-coupled electrical components, and can include, for example, a memory, a processor, electrical traces, optical connectors, software (executing or to be executed in hardware) and/or the like. Furthermore, a module can be capable of performing one or more specific functions associated with the module, as discussed further below.

The transaction management platform 200 can provide transaction management to a mobile device 13a and 13b as a stand-alone service or as an additional service to applications provided by the application servers 31 and 25 for the mobile devices 13a and 13b and the user terminals 27. The input processing module 201 can receive an input from the mobile device 13a or 13b. The input may include an e-mail address associated with a user of the mobile device 13a or 13b. For example, the e-mail address of the user may have been previously stored in a user profile on the mobile device 13a or 13b. The input may also include payment data associated with a sale transaction of the user such as, for example, credit card information. For example, the transaction management platform 200 can be associated with a POS device 105 of FIG. 1 at a store and the input processing module 201 may be a component of the POS device 105 that receives the e-mail address and the payment data from the mobile device 13a or 13b via a NFC device or by a scanner reading a Quick Response (QR) code (e.g., a barcode) displayed on an interface of the mobile device 13a or 13b. Alternatively the input processing module 201 may receive the input from an application server 25 or 31, wherein the application server 25 or 31 receives the input from the POS device 105 that directly communicates with the mobile device 13a or 13b. The input processing module 201 may store the received input in data store 209.

The data analysis module 203 can receive the input data from the input processing module 201 or from the data store 209 and extract the e-mail address associated with the user from the input data. For example, the data analysis module 203 may use a patent recognition or text recognition technique to distinguish a format of the email address. The data analysis module 203 may store the extracted e-mail address in data store 209. In addition, the data analysis module 203 can send the e-mail address to the output module 207 and the output module 207 can send a request to an application server 25 or 31, including the e-mail address such that the application server 25 or 31 can send information associated with the transaction to the e-mail address. The application server 25 or 31 can be, for example, a server associated with a merchant that is in turn associated with the POS device 105. Upon receiving the request from the output module 207, the application server 25 or 31 can send information associated with the sale transaction to the e-mail address.

The data analysis module 203 can also extract the payment data associated with the user from the input data. The data analysis module 203 may store the extracted payment data in data store 209. In addition, the data analysis module 203 can send the payment data to the output module 207 and the output module 207 can send the payment data to an application server 25 or 31 such that the application server 25 or 31 can determine information associated with the sale transaction based on the payment data. The information associated with the sale transaction can include an electronic receipt including a monetary value, date and time of the transaction, merchant's name, etc. The repository control module 205 can store the e-mail address of the user in an e-mail address repository 211a of the data store 209. The repository control module 205 may also store the transaction information (e.g., the electronic receipt) in a transaction information repository 211b of the data store 209. The data store 209 including the e-mail address repository 211a and the transaction information repository 211b can be located in any location throughout network 10. The repository control module 205 may seek user's approval via the mobile device 13a or 13b prior to storing the user's email address in the e-mail address repository 211a and prior to storing the transaction information in the transaction information repository 211b. The transaction management platform 200 may provide access to the data store 209 to an application server 25 or 31 and to the mobile device 13a or 13b. For example, a user of the mobile device 13a or 13b may be enabled to sign up for accessing the e-mail address repository 211a and the transaction information repository 211b and provided with a credential for the access. The user may access the e-mail address repository 211a or the transaction information repository 211b via the mobile device 13a or 13b or via a user terminal 27.

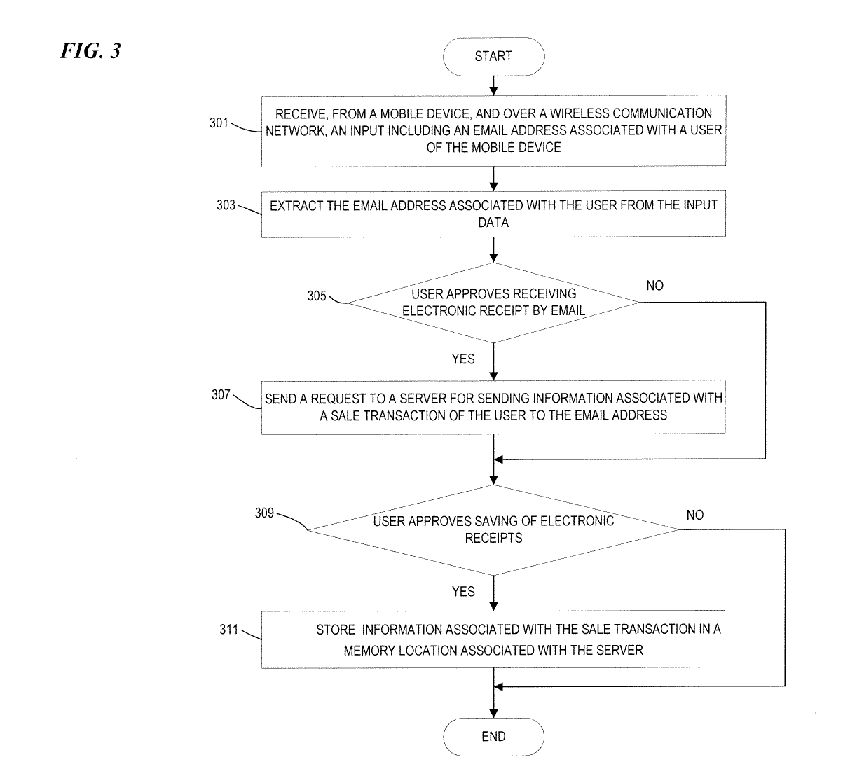

FIG. 3 is an exemplary process for providing electronic transaction management service. Although FIG. 3 is described with reference to FIGS. 1 and 2, the subject technology is not limited to such and can apply to other computing devices and systems. At block 301, an input processing module 201 of a transaction management platform 200 (e.g., a POS device 105), receives an input from a mobile device 13a or 13b. The input data may be received at the input processing module 201 from the mobile device 13a or 13b, via a Near Field Communication (NFC) device. In other instances, the input data may be received at input processing module 201 from the mobile device 13a or 13b, via a QR code scanner device. For example, the user of the mobile device 13a or 13b may activate a client application on the mobile device by selecting an icon associated with the client application on the mobile device. Upon activation, the client application may display a QR code on a display of the mobile device or activate a NFC component on the mobile device. The user may then touch the mobile device 13a or 13b to a POS device 105 such that the POS device 105 reads an input from the mobile device via the QR code or the NFC.

The input may include data such as an e-mail address of a user of the mobile device, payment data associated with a sale transaction of the user (e.g., a purchase by the user), etc. Alternatively, the POS device 105 may receive the payment data from sources associated with the user other than the mobile device 13a or 13b. For example, the user may use a credit card to send the payment data to the POS device 105. The input processing module 201 may store the input in a data store 209. At block 303, the data analysis module 203 extracts the e-mail address associated with the user from the input data and saves the e-mail address in data store 209. At block 305, the output module 207 sends a request to the mobile device 13a or 13b asking for user's approval for receiving an electronic receipt by e-mail. The output module 207 may send a request to the mobile device 13a or 13b via the POS device 105 or directly via the communication network 15. The user may respond to the request via the POS device 105 through the NFC or QR code as discussed above, or directly via the communication network 15. If the user, in response to the request, indicates acceptance of electronic receipt via e-mail, at block 307 the output module 207 sends a request to an application server 25 or 31 associated with a merchant to request for sending information associated with the sale transaction (e.g., an electronic receipt) to the e-mail address of the user. The request may include the e-mail address.

At block 309, the output module 207 sends a request to the mobile device 13a or 13b asking for user's approval for saving the electronic receipt in a repository (e.g., the transaction information repository 211b). If the user, in response to the request, indicates approving that the electronic receipt being saved, at block 311 the repository control module 205 stores the information associated with the sale transaction in a memory location (the transaction information repository 211b) associated with the application server 25 or 31.

Moreover, the data analysis module 203 may also extract the payment data (e.g., credit card data, bank account data, etc.) of the user from the input data. In such cases, the output module 207 can send the payment data to the application server 25 or 31 such that the server can determine information associated with the sale transaction (e.g., produce an electronic receipt) based on the payment data.

In some instances, the output module 207 may remove the e-mail address from the data store 209 after the e-mail address is sent to the application server 25 or 31, as shown in block 307. In some other instances, the repository control module 205 stores the e-mail address associated with the user in a memory location associated with the user such as, for example, the e-mail address repository 211a. The repository control module 205 may send a request, via the output module 207, to the mobile device 13a or 13b for a storage approval of the e-mail address prior to storing the e-mail address in the e-mail address repository 211a and store the e-mail address in the repository based on a response from the mobile device 13a or 13b to the request for storage approval.

Prior to extracting the e-mail address from the input data (as shown in block 303) the data analysis module 203 may search the e-mail address repository 211a for a stored e-mail address associated with a user of the mobile device 13a or 13b. In such cases, if a stored e-mail address associated with the user is identified in the e-mail address repository 211a, the data analysis module 203 may send the stored e-mail address with the request to the application server 25 or 31 for sending information associated with the sale transaction to the stored e-mail address. The data analysis module 203 extracts the e-mail address from the input data, if no stored e-mail address can be identified in the e-mail address repository 211a. In addition, the data analysis module 203 may request for user's approval of the stored email address, which, as above is sent to the user, to insure that the e-mail address on file is still valid, via the output module 207. If the user response indicates that the stored e-mail address is invalid, the data analysis module 203 may request a current e-mail address of the user.

In some instances, the transaction management platform 200 may receive an access request from the mobile device 13a or 13b via the communication network 15 indicating a request from the user to access the information associated with multiple sale transactions associated with the user which have been stored in the transaction information repository 211b. In such instances, the repository control module 205 may request user credentials in order to determine user's authorization for accessing the transaction information. The user may enter the credentials via the mobile device 13a or 13b or a user terminal 27 into an input window provided by the transaction management platform 103. Upon authentication, the repository control module 205 may permit the user to access the stored information associated with the sale transactions via the mobile device 13a or 13b or the user terminal 27. For example, the repository control module 205 may provide a list of electronic receipts of the user on a user interface of the mobile device 13a or 13b or the user terminal 27. The repository control module 205 may also provide various functions to the user to categorize the electronic receipts. For example, the repository control module 205 may provide to the user access to the transaction information, such as the electronic receipts, via the mobile device 13a or 13b or via a user terminal 27 such that the transactions are grouped by merchant or as a separate list for each merchant, as indicated by the user. The user may also be enabled by the repository control module 205 to access (e.g., categorize, search, print, query) the transaction information by merchant's name, by merchant's address, by date of the transactions, by time of the transactions, by a date range or time range of the transactions, by a monetary amount or monetary range of the transactions, etc. In addition, the data analysis module 203 may provide various statistical analyses on the transaction information to the user such as, for example, a weekly, monthly, or annual report of trends in the user's expenditures showing, for example, on what items or merchants the user intends to spend more, etc. The transaction management platform 200 may provide the stored transaction information and the related functions to the user via a Mobile Wallet® service to the mobile device 13a or 13b or a user terminal 27 of the user.

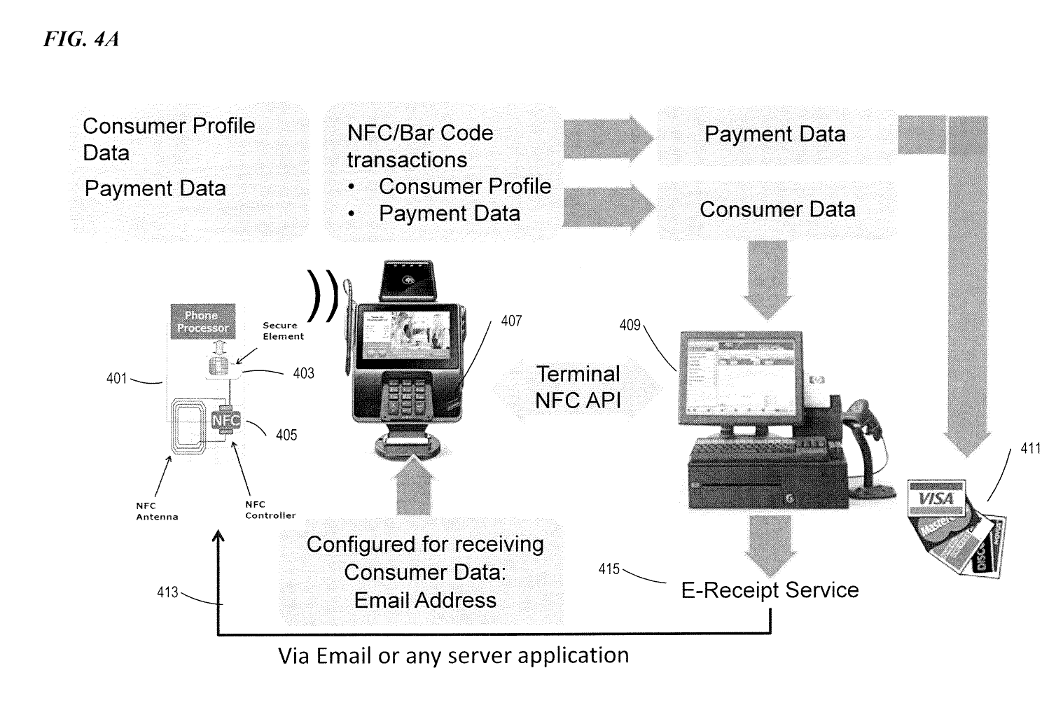

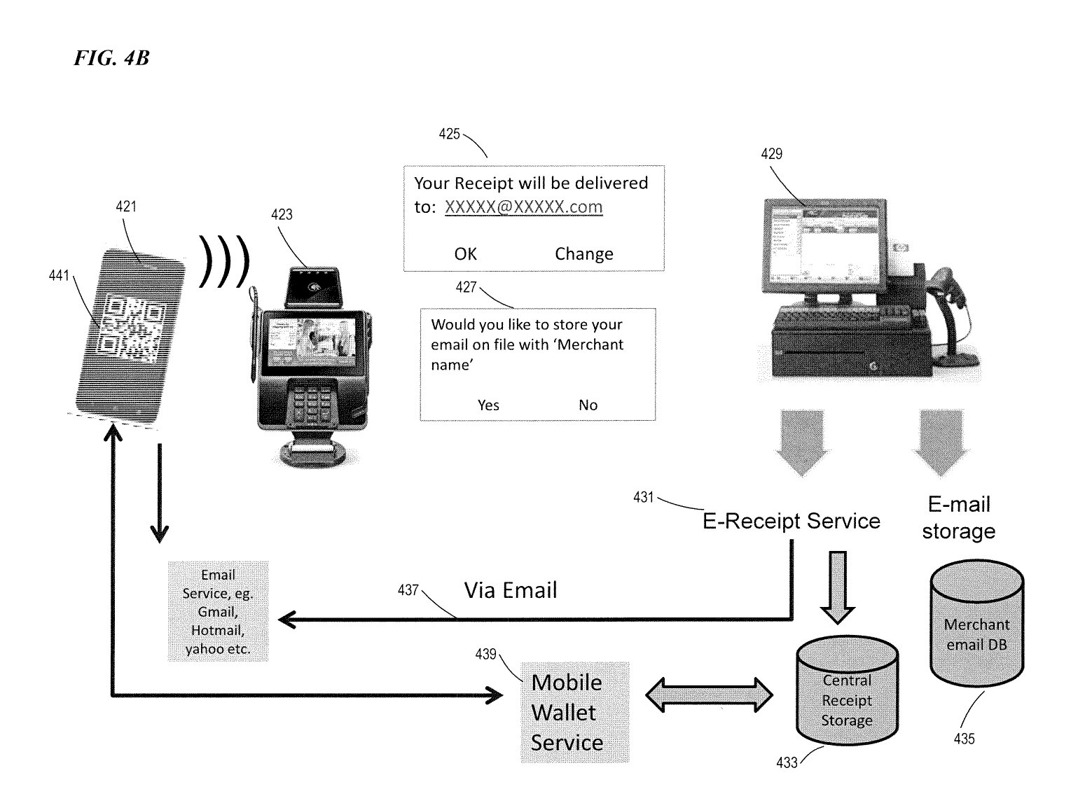

FIGS. 4A-4B are exemplary flow diagrams for providing electronic transaction management service. FIG. 4A is a flow diagram of sending an electronic receipt to a user by an electronic message (e.g., e-mail). In various aspects, a user of a mobile device 401 (similar to the mobile devices 13a or 13b of FIG. 1) can request a transaction service from the transaction management platform 200, for example, by selecting an icon or pressing a button (not shown) on the mobile device 401. The user selection may start a mobile application on the mobile device 401 to communicate with the transaction management platform 200.

As discussed above with respect to FIGS. 2 and 3, the components of the transaction management platform 200 can be collocated in one location or located in different locations throughout the network 10 of FIG. 1. In various examples, all or some of the modules of the transaction management platform 200 can be located within a terminal device 407, within the POS device 409 (similar to the POS device 105 of FIG. 1) or in different locations throughout the network 10 of FIG. 1. For example, the POS device 409 can be similar to the input processing unit 201 of the transaction management platform 200. Alternatively, the POS device 409 can be an interface for receiving a user input from the mobile device 401, via the terminal device 407, and sending the input to the transaction management platform 200 in a different location (not shown).

In various instances, data exchange between the mobile device 401 and the POS device 409 can be via a Near Field Communication (NFC) 405 or via a QR code scanned by the terminal device 423 (shown in FIG. 4B). In response to the user input, the POS device 409 can read a user profile stored on mobile device 401 (for example on a secure element 403 of the mobile device 401) and send the profile to the transaction management platform 200. The user profile may include personal information associated with a user of the mobile device 401 (e.g., name, ID, contact information, etc.) and payment data associated with the user (e.g., credit card data, bank account data, etc.). The transaction management platform 200 can extract the user's contact information and the payment data from the user profile.

Subsequently, the transaction management platform 200 can send the payment data to a server (similar to application server 25 or 31) for processing. For example, the application server (not shown in FIG. 4A) can be a merchant's transaction processing server. In other instances, the POS device 409 can communicate with a bank server 411 (similar to server 107 of FIG. 1) to process the payment using the payment data. In addition, the transaction management platform 200 can send the user's contact information to application server 25 or 31 such that the application server can send an electronic receipt to the user (shown by arrow 413), by e-mail, text message, image message, etc., using an electronic receipt service 415.

FIG. 4B is a flow diagram of sending an electronic receipt to a user by an electronic message (e.g., e-mail) and providing a repository of electronic receipts to the user and/or the merchant. In various aspects, a user of a mobile device 421 (similar to the mobile devices 13a or 13b of FIG. 1) can request a transaction service from the transaction management platform 200, for example, by selecting an icon or pressing a button (not shown) on the mobile device 421. The user selection may start an application on the mobile device 421 to communicate with the transaction management platform 200.

In various examples, all or some of the modules of the transaction management platform 200 can be located within the POS device 429, or in different locations throughout the network 10 of FIG. 1. For example, the POS device 429 can be similar to the input processing module 201 of the transaction management platform 200. Alternatively, the POS device 429 can be an interface for receiving a user input from the mobile device 421 and sending the input to the transaction management platform 200 in a different location (not shown).

In the example of FIG. 4B, data exchange between the mobile device 421 and the POS device 429 can be via a QR code 441 scanned by the terminal device 423. In response to the user input, the POS device 429 can read a user profile stored on mobile device 421 and send the profile to the transaction management platform 200. The user profile may include personal information associated with a user of the mobile device 421 (e.g., name, ID, contact information, etc.) and payment data associated with the user (e.g., credit card data, bank account data, etc.). The transaction management platform 200 can extract the user's contact information and the payment data from the user profile.

Subsequently, the transaction management platform 200 can display a message 425 on a user interface of the mobile device 421 requesting user's approval for the electronic receipt being delivered to the extracted contact information (e.g., e-mail address xxxxx@xxxxx.com). The user can be given an option to either approve the contact information or enter different contact information for the electronic receipt to be sent to. Upon approval of the contact information by the user, the transaction management platform 200 can send the user's contact information to an application server 25 or 31 such that the application server can send an electronic receipt to the user (shown by arrow 437), by e-mail, text message, image message, etc., using an electronic receipt service 431.

The transaction management platform 200 may also display a screen 427 on a user interface of the mobile device 421 asking whether the user would like to store the electronic receipt in a repository. The transaction management platform 200 can then store the electronic receipt in a repository. For example the transaction management platform 200 may store the electronic receipts for multiple merchants in a central receipt storage 433. In addition, the transaction management platform 200 may store the e-mails including the electronic receipts in an e-mail database 435 for each merchant.

In some instances, the transaction management platform 200 can provide access to the electronic receipt repository to the user via a mobile device 13a or 13b. The transaction management platform 200 may also provide access to the electronic receipts associated with each merchant to the merchant via mobile devices 13a and 13b or user terminals 27 of the merchant. The transaction management platform 200 may provide access to the electronic receipts repository via a mobile wallet service 439 such as, for example, ISIS Wallet®, Google® Wallet, etc.

Those skilled in the art presumably are familiar with the structure, programming and operations of the various types of mobile devices. However, for completeness, it may be useful to consider the functional elements/aspects of two exemplary mobile devices 13a and 13b, at a high-level.

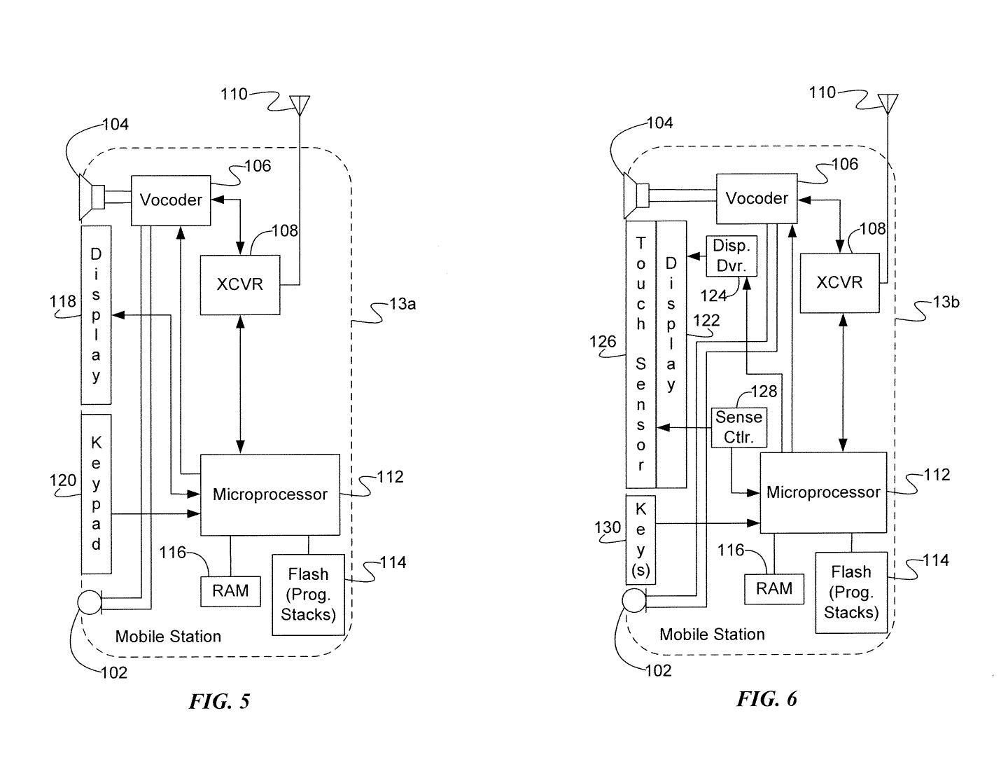

For purposes of such a discussion, FIG. 5 is a high-level functional block diagram of an exemplary non-touch type mobile device that may utilize the electronic transaction management service through a network/system like that shown in FIG. 1. FIG. 5 provides a block diagram illustration of an exemplary non-touch type mobile device 13a. Although the mobile device 13a may be a smart-phone or may be incorporated into another device, such as a personal digital assistant (PDA) or the like, for discussion purposes, the illustration shows the mobile device 13a is in the form of a handset. The handset implementation of the mobile device 13a functions as a normal digital wireless telephone station. For that function, the station 13a includes a microphone 102 for audio signal input and a speaker 104 for audio signal output. The microphone 102 and speaker 104 connect to voice coding and decoding circuitry (vocoder) 106. For a voice telephone call, for example, the vocoder 106 provides two-way conversion between analog audio signals representing speech or other audio and digital samples at a compressed bit rate compatible with the digital protocol of wireless telephone network communications or voice over packet (Internet Protocol) communications.

For digital wireless communications, the handset 13a also includes at least one digital transceiver (XCVR) 108. Today, the handset 13a would be configured for digital wireless communications using one or more of the common network technology types. The concepts discussed here encompass implementations of the mobile device 13a utilizing any digital transceivers that conform to current or future developed digital wireless communication standards. The mobile device 13a may also be capable of analog operation via a legacy network technology.

The transceiver 108 provides two-way wireless communication of information, such as vocoded speech samples and/or digital information, in accordance with the technology of the network 15. The transceiver 108 also sends and receives a variety of signaling messages in support of the various voice and data services provided via the mobile device 13a and the communication network. Each transceiver 108 connects through RF send and receive amplifiers (not separately shown) to an antenna 110. The transceiver may also support various types of mobile messaging services, such as short message service (SMS), enhanced messaging service (EMS) and/or multimedia messaging service (MMS).

The mobile device 13a includes a display 118 for displaying messages, menus or the like; call related information dialed by the user, calling party numbers, etc. A keypad 120 enables dialing digits for voice and/or data calls as well as generating selection inputs, for example, as may be keyed-in by the user based on a displayed menu or as a cursor control and selection of a highlighted item on a displayed screen. The display 118 and keypad 120 are the physical elements providing a textual or graphical user interface. Various combinations of the keypad 120, display 118, microphone 102 and speaker 104 may be used as the physical input output elements of the graphical user interface (GUI), for multimedia (e.g., audio and/or video) communications. Of course other user interface elements may be used, such as a trackball, as in some types of PDAs or smart phones.

In addition to normal telephone and data communication related input/output (including message input and message display functions), the user interface elements also may be used for display of menus and other information to the user and user input of selections, including any needed during transaction management process. For example, if used for transaction management provided by a transaction management platform 200.

A microprocessor 112 serves as a programmable controller for the mobile device 13a, in that it controls all operations of the mobile device 13a in accord with programming that it executes, for all normal operations, and for operations involved in the transaction management procedure under consideration here. In the example, the mobile device 13a includes flash type program memory 114, for storage of various “software” or “firmware” program routines and mobile configuration settings, such as mobile directory number (MDN) and/or mobile identification number (MIN), etc. The mobile device 13a may also include a non-volatile random access memory (RAM) 116 for a working data processing memory. Of course, other storage devices or configurations may be added to or substituted for those in the example. In a present implementation, the flash type program memory 114 stores firmware such as a boot routine, device driver software, an operating system, call processing software and vocoder control software, and any of a wide variety of other applications, such as client browser software and short message service software. The memories 114, 116 also store various data, such as telephone numbers and server addresses, downloaded data such as multimedia content, and various data input by the user. Programming stored in the flash type program memory 114, sometimes referred to as “firmware,” is loaded into and executed by the microprocessor 112.

As outlined above, the mobile device 13a includes a processor, and programming stored in the flash memory 114 configures the processor so that the mobile device is capable of performing various desired functions, including in this case the functions involved in the technique for providing transaction management services. For example, any of the modules of the transaction management platform 200 or any parts of the modules can be located on the mobile device 13a or 13b. The mobile device 13a or 13b also includes an NFC controller and an NFC antenna for Near Field Communication with other devices such as a POS device.

For purposes of such a discussion, FIG. 6 is a high-level functional block diagram of an exemplary touch screen type mobile device that may utilize the electronic transaction management service through a network/system like that shown in FIG. 1. FIG. 6 provides a block diagram illustration of an exemplary touch screen type mobile device 13b. Although possible configured somewhat differently, at least logically, a number of the elements of the exemplary touch screen type mobile device 13b are similar to the elements of mobile device 13a, and are identified by like reference numbers in FIG. 6. For example, the touch screen type mobile device 13b includes a microphone 102, speaker 104 and vocoder 106, for audio input and output functions, much like in the earlier example. The mobile device 13b also includes at least one digital transceiver (XCVR) 108, for digital wireless communications, although the handset 13b may include an additional digital or analog transceiver. The concepts discussed here encompass implementations of the mobile device 13b utilizing any digital transceivers that conform to current or future developed digital wireless communication standards. As in the station 13a, the transceiver 108 provides two-way wireless communication of information, such as vocoded speech samples and/or digital information, in accordance with the technology of the network 15. The transceiver 108 also sends and receives a variety of signaling messages in support of the various voice and data services provided via the mobile device 13b and the communication network. Each transceiver 108 connects through RF send and receive amplifiers (not separately shown) to an antenna 110. The transceiver may also support various types of mobile messaging services, such as short message service (SMS), enhanced messaging service (EMS) and/or multimedia messaging service (MMS).

As in the example of station 13a, a microprocessor 112 serves as a programmable controller for the mobile device 13b, in that it controls all operations of the mobile device 13b in accord with programming that it executes, for all normal operations, and for operations involved in the transaction management procedure under consideration here. In the example, the mobile device 13b includes flash type program memory 114, for storage of various program routines and mobile configuration settings. The mobile device 13b may also include a non-volatile random access memory (RAM) 116 for a working data processing memory. Of course, other storage devices or configurations may be added to or substituted for those in the example. Hence, outlined above, the mobile device 13b includes a processor, and programming stored in the flash memory 114 configures the processor so that the mobile device is capable of performing various desired functions, including in this case the functions involved in the technique for providing transaction management service.

In the example of FIG. 5, the user interface elements included a display and a keypad. The mobile device 13b may have a limited number of key 130, but the user interface functions of the display and keypad are replaced by a touch screen display arrangement. At a high level, a touch screen display is a device that displays information to a user and can detect occurrence and location of a touch on the area of the display. The touch may be an actual touch of the display device with a finger, stylus or other object, although at least some touch screens can also sense when the object is in close proximity to the screen. Use of a touch screen display as part of the user interface allows a user to interact directly with the information presented on the display.

Hence, the exemplary mobile device 13b includes a display 122, which the microprocessor 112 controls via a display driver 124, to present visible outputs to the device user. The mobile device 13b also includes a touch/position sensor 126. The sensor 126 is relatively transparent, so that the user may view the information presented on the display 122. A sense circuit 128 sensing signals from elements of the touch/position sensor 126 and detects occurrence and position of each touch of the screen formed by the display 122 and sensor 126. The sense circuit 128 provides touch position information to the microprocessor 112, which can correlate that information to the information currently displayed via the display 122, to determine the nature of user input via the screen.

The display 122 and touch sensor 126 (and possibly one or more keys 130, if included) are the physical elements providing the textual and graphical user interface for the mobile device 13b. The microphone 102 and speaker 104 may be used as additional user interface elements, for audio input and output, including with respect to some transaction management related functions.

The structure and operation of the mobile devices 13a and 13b, as outlined above, were described by way of example, only. As shown by the above discussion, functions relating to the transaction management service, via a graphical user interface of a mobile device may be implemented on computers connected for data communication via the components of a packet data network, operating as shown in FIG. 1. Although special purpose devices may be used, such devices also may be implemented using one or more hardware platforms intended to represent a general class of data processing device commonly used to run “server” programming so as to implement the transaction management functions discussed above, albeit with an appropriate network connection for data communication.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. files used for transaction management service. The software code is executable by the general-purpose computer that functions as the transaction management platform and/or that functions as a user terminal device. In operation, the code is stored within the general-purpose computer platform. At other times, however, the software may be stored at other locations and/or transported for loading into the appropriate general-purpose computer system. Execution of such code by a processor of the computer platform enables the platform to implement the methodology for transaction management service, in essentially the manner performed in the implementations discussed and illustrated herein.

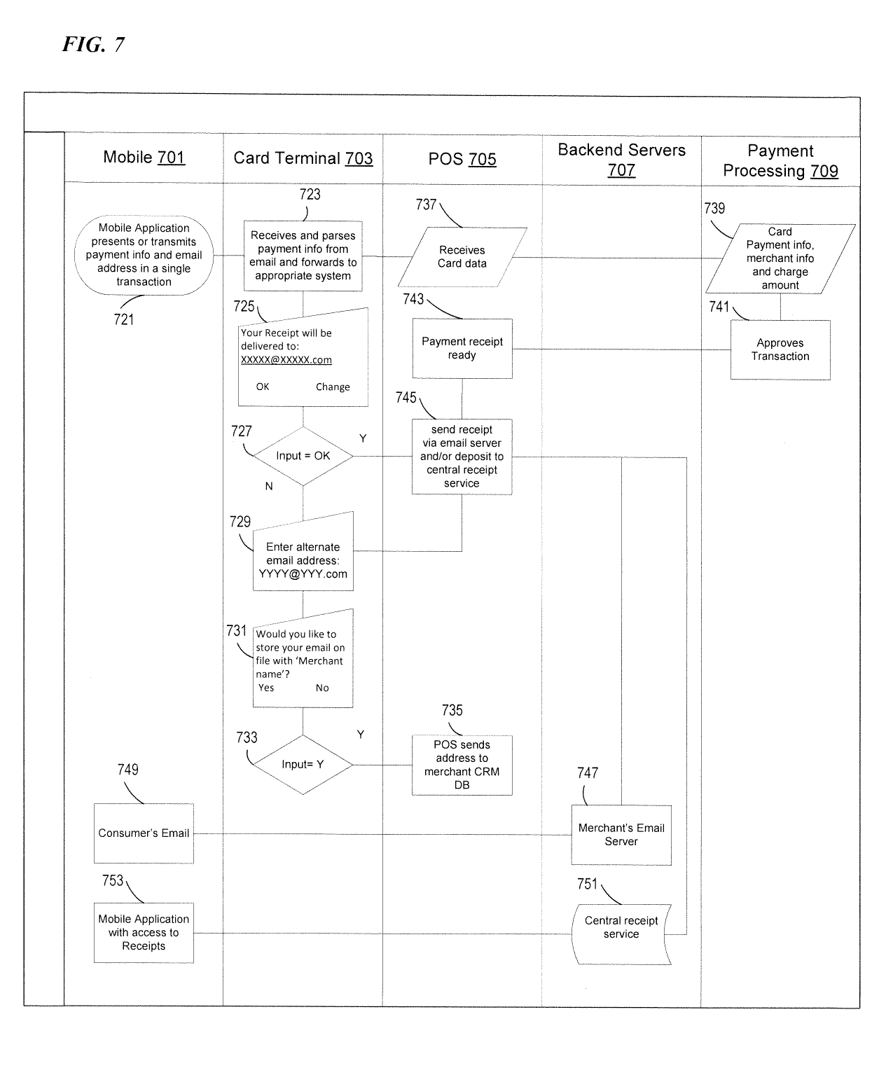

FIG. 7 is a diagram of an exemplary process for providing electronic transaction management service. As shown in step 721, a user of a mobile device 701 (similar to mobile device 13a or 13b of FIG. 1) can use a mobile application on the mobile device to transmit his/her e-mail address and payment data, in a single transaction, over a NFC device or via a barcode reader to a card terminal 703. The card terminal 703 can be a component of the transaction management platform 200 of FIG. 2 such as, the input processing module 201. For example, the e-mail address may be stored on the mobile device 701 on the secure element of the mobile device or on a memory location of the mobile device 701 associated with the mobile application. The card terminal 703, at step 723, receives the payment data and the e-mail address.

At step 725, the output module 207 can send a message to be displayed on a user interface of the mobile device 701, via the card terminal 703, confirming that an electronic receipt will be sent to the user e-mail address provided. At step 727 the user can either accept or reject receiving an electronic receipt to the provided e-mail by responding to the message. If the user rejects the request, per step 729 the output module 207 may request for an alternate e-mail address for receiving the electronic receipt, via the card terminal 703. At step 731, the output module 207 displays a message on the user interface of the mobile device 701 asking the user for approval of saving the e-mail address. If the user approves saving the e-mail address, at step 733, the POS device 703 sends the e-mail address to the backend server 707 (similar to application server 25 or 31) of the merchant and at step 735 the e-mail address is stored in a database (e.g., the e-mail address repository 211a).

Referring back to step 727, if the user accepts the request for receiving electronic receipt via e-mail, at step 745 the POS device 705 sends the receipt to the backend server 707 of the merchant. The POS device 705 may also determine for the electronic receipt to be stored in a receipt repository (e.g., a transaction information repository 211b associated with the merchant or a central storage associated with multiple merchants).

In various instances, the transaction information repository 211b can be a private repository for each merchant or a central repository for multiple merchants such that a user can have access to all of his/her receipts for various merchants in one place. Referring back to step 723, at step 737 the POS device 705 receives the payment data from the card terminal 703 and sends the data to a payment processing device 709, at step 739 to be processed. Upon approval of the transaction by the payment processing device 709, at step 741, the payment processing device 709 sends the electronic receipt to the POS device 705, at step 743. At step 745, the POS device 705 determines to send the receipt to the user's e-mail address based on the user's response of step 727, discussed above.

At step 747, the backend server 707 sends the electronic receipt to an e-mail server associated with the merchant and the e-mail server sends the electronic receipt to the user's e-mail address per step 749. In addition, if in step 745 the POS device determines for the electronic receipt to be stored in a repository, at step 751 the backend server 707 stores the electronic receipt in the repository 211b and at step 753 the backend server 707 provides access to the repository 211b to the mobile device 701, for example, via a mobile application.

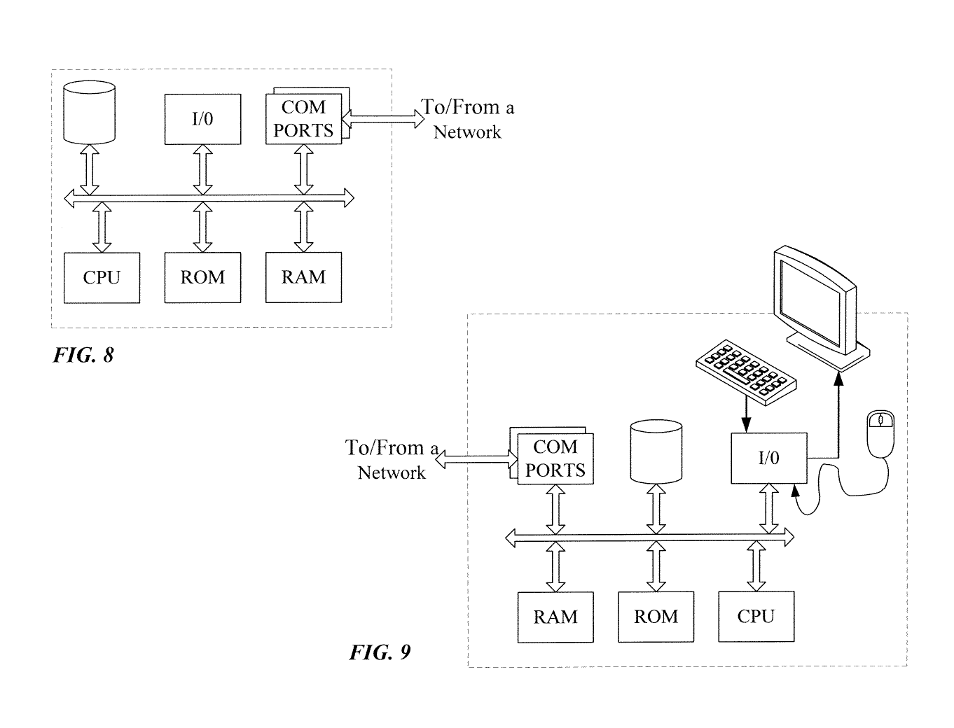

FIGS. 8 and 9 provide functional block diagram illustrations of general purpose computer hardware platforms. FIG. 8 illustrates a network or host computer platform, as may typically be used to implement a server. FIG. 9 depicts a computer with user interface elements, as may be used to implement a personal computer or other type of work station or terminal device, although the computer of FIG. 9 may also act as a server if appropriately programmed. It is believed that those skilled in the art are familiar with the structure, programming and general operation of such computer equipment and as a result the drawings should be self-explanatory.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. Of course, the server functions may be implemented in a distributed fashion on a number of similar platforms, to distribute the processing load.

A computer type user terminal device, such as a PC or tablet computer, similarly includes a data communication interface CPU, main memory and one or more mass storage devices for storing user data and the various executable programs (see FIG. 8). A mobile device type user terminal may include similar elements, but will typically use smaller components that also require less power, to facilitate implementation in a portable form factor. The various types of user terminal devices will also include various user input and output elements. A computer, for example, may include a keyboard and a cursor control/selection device such as a mouse, trackball, joystick or touchpad; and a display for visual outputs. A microphone and speaker enable audio input and output. Some smartphones include similar but smaller input and output elements. Tablets and other types of smartphones utilize touch sensitive display screens, instead of separate keyboard and cursor control elements. The hardware elements, operating systems and programming languages of such user terminal devices also are conventional in nature, and it is presumed that those skilled in the art are adequately familiar therewith.

Hence, aspects of the methods of providing transaction management services outlined above may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the transaction management platform 200 into the computer platform of the application server 25 that will be the application server for the mobile devices 13a, and 13b or the user terminal 27. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the transaction management service, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

While the above discussion primarily refers to processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

Many of the above described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions.

In this specification, the term “software” is meant to include firmware residing in read-only memory or applications stored in magnetic storage, which can be read into memory for processing by a processor. Also, in some implementations, multiple software operations can be implemented as sub-parts of a larger program while remaining distinct software operations. In some implementations, multiple software operations can also be implemented as separate programs. Finally, any combination of separate programs that together implement a software invention described herein is within the scope of the invention. In some implementations, the software programs, when installed to operate on one or more electronic systems, define one or more specific machine implementations that execute and perform the operations of the software programs.

A computer program (also known as a program, software, software application, script, application, or code) can be written in any form of programming language, including compiled or interpreted language, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

It is understood that any specific order or hierarchy of steps in the processes disclosed herein is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

The implementations described hereinabove are further intended to explain and enable others skilled in the art to utilize the invention in such, or other, implementations and with the various modifications required by the particular applications or uses of the invention. Accordingly, the description is not intended to limit the invention to the form disclosed herein.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations for the purpose of streamlining the disclosure. This method of disclosure is not to be interpreted as reflecting an intention that the claimed implementations require more features than are expressly recited in each claim. Rather, as the following claims reflect, inventive subject matter lies in less than all features of a single disclosed implementation. Thus the following claims are hereby incorporated into the Detailed Description, with each claim standing on its own as a separately claimed subject matter.

What is claimed is:

1. A method comprising:
receiving, at a point of sale device and from a mobile device, input data associated with a sale transaction of a user of the mobile device, the input data including an e-mail address associated with the user of the mobile device, wherein the input data is received at the point of sale device over a wireless communication network;
extracting, at the point of sale device, the e-mail address associated with the user from the input data, or from a memory location associated with the user; and
in response to extracting the email address, sending, from the point of sale device and to a server, a request for sending information associated with the sale transaction to the e-mail address.

2. The method of claim 1, wherein the input data further includes payment data associated with the sale transaction, the method further comprising:
extracting, at the point of sale device, the payment data from the input data; and
sending, from the point of sale device, the payment data to the server, wherein the information associated with the sale transaction is determined based on the payment data.

3. The method of claim 2, wherein the wireless communication network is a mobile network or a short range network, and wherein the short range network includes Near Field Communication (NFC), Quick Response (QR) code communication, Bluetooth communication, or a combination thereof.

4. The method of claim 1, further comprising:
sending, from the point of sale device and to the mobile device, a request for an approval of usage of the e-mail address, wherein sending the request to the server is at least based on a response, from the mobile device, to the request for approval.

5. The method of claim 1, further comprising:
if the e-mail address is extracted from the input data, sending, from the point of sale device and to the mobile device, a request for a storage approval of the e-mail address; and
storing the e-mail address associated with the user in the memory location associated with the user, at least based on a response, from the mobile device, to the request for storage approval.

6. A method comprising:
receiving, at a point of sale device and from a mobile device, an input associated with a sale transaction of a user of the mobile device, the input including payment data associated with the sale transaction, wherein the input data is received at the point of sale device over a wireless communication network;
extracting, at the point of sale device, the payment data associated with the user from the input data;
sending, from the point of sale device and to a server, the payment data, wherein the server determines information associated with the sale transaction based on the payment data; and
storing, by the point of sale device, the information associated with the sale transaction in a memory location associated with the server.

7. The method of claim 6, wherein the input data further includes an e-mail address associated with the user, the method further comprising:
extracting, at the point of sale device, the e-mail address, from the input data; and
sending, from the point of sale device and to the server, a request for sending the information associated with the sale transaction to the e-mail address.

8. The method of claim 6, further comprising:
sending, from the point of sale device and to the mobile device, a request for storage approval of the information associated with the sale transaction, wherein the storing is at least based on a response, from the mobile device, to the request for storage approval.

9. The method of claim 6, further comprising:
receiving, at the point of sale device and from the mobile device, an access request to the information associated with the sale transaction associated with the user of the mobile device; and
permitting the user to access the stored information associated with the sale transaction via the mobile device, based on a user profile.

10. The method of claim 9, wherein the stored information associated with the sale transaction is available to the mobile device via a mobile wallet service.

11. The method of claim 7, further comprising:
sending, from the point of sale device and to the mobile device, a request for an approval of usage of the e-mail address, wherein the request for sending is at least based on a response, from the mobile device, to the request for approval.

12. A system comprising:
a processing device; and
a memory storing executable instructions that, when executed by the processing device, cause the processing device to:
receive, at a point of sale device and from a mobile device, input data associated with a sale transaction of a user of the mobile device, the input data including an e-mail address associated with the user of the mobile device, wherein the input data is received at the point of sale device over a wireless communication network;
extract, at the point of sale device, the e-mail address associated with the user from the input data; and
in response to extracting the email address, send, from the point of sale device and to a server, a request for sending information associated with the sale transaction to the e-mail address.

13. The system of claim 12, wherein the input data further includes payment data associated with the sale transaction, and the instructions further cause the processing device to:
extract, at the point of sale device, the payment data from the input data; and
send the payment data to the server, wherein the information associated with the sale transaction is determined based on the payment data.

14. The system of claim 12, wherein the wireless communication network is a mobile network or a short range network, and wherein the short range network includes Near Field Communication (NFC), Quick Response (QR) code communication, or a combination thereof.

15. The system of claim 12, wherein the instructions further cause the processing device to:
send, from the point of sale device and to the mobile device, a request for an approval of usage of the e-mail address, wherein sending the request to the server is at least based on a response, from the mobile device, to the request for approval.

16. A system comprising:
a processing device; and
a memory storing executable instructions that, when executed by the processing device, cause the processing device to:
receive, at a point of sale device and from a mobile device, an input associated with a sale transaction of a user of the mobile device, the input including payment data associated with the sale transaction, wherein the input data is received at the point of sale device over a wireless communication network;
extract, at the point of sale device, the payment data associated with the user from the input data;
send, from the point of sale device and to a server, the payment data, wherein the server determines information associated with the sale transaction based on the payment data; and
store, by the point of sale device, the information associated with the sale transaction in a memory location associated with the server.

17. The system of claim 16, wherein the input data further includes an e-mail address associated with the user, and the instructions further cause the processing device to:
extract, at the point of sale device, the e-mail address, from the input data; and
send, from the point of sale device and to the server, a request for sending the information associated with the sale transaction to the e-mail address.

18. The system or claim 16, wherein the instructions further cause the processing device to:
send, from the point of sale device and to the mobile device, a request for storage approval of the information associated with the sale transaction, wherein the storing is at least based on a response, from the mobile device, to the request for storage approval.

19. The system of claim 16, wherein the instructions further cause the processing device to:
receive, at the point of sale device and from the mobile device, an access request to the information associated with the sale transaction associated with the user of the mobile device; and
permit the user to access the stored information associated with the sale transaction via the mobile device, based on a user profile.

20. The system of claim 19, wherein the stored information associated with the sale transaction is available to the mobile device via a mobile wallet service.
